(19) United States
(12) Patent Application Publication
(10) Pub. No.: US 2007/0042255 A1
(43) Pub. Date: Feb. 22, 2007

(54) Seal for fuel cell

(76) Inventors: Seungsoo Jung, Vancouver (CA); Robert H. Artibise, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/207,579

(22) Filed: Aug. 19, 2005

(51) Int. Cl. H01M 2/08; H01M 8/10; H01M 8/02

(52) U.S. Cl. 429/35; 429/30; 429/38; 29/623.2

(57) ABSTRACT

A membrane electrode assembly comprises an edge seal member, the edge seal member having a first compressive surface and an opposing second compressive surface wherein the first compressive surface comprises a seal protrusion and the opposing second compressive comprises an inner and outer seal protrusion. The seal protrusion on the first compressive surface is positioned asymmetrically in relation to the inner and outer seal protrusions on the second compressive surface such that the centerline of the seal protrusion on the first compressive surface is positioned between the centerline of the inner seal protrusion and the centerline of the outer seal protrusion on the second compressive surface. The seal protrusions may be shaped such that the base is wide and narrows toward a contacting end thereof, wherein the contacting end is in contact with a surface of a flow field plate. The geometry and positions of the seal protrusions can be adjusted to optimize the contact pressure on the edge seal member and contacting points thereof.

### BACKGROUND OF THE INVENTION

1. Field of the Invention

The present invention generally relates to a seal for a solid polymer electrolyte membrane fuel cell and fuel cell stack comprising a plurality of such fuel cells and, more particularly, to fuel cell stacks employing over-pressure operation.

2. Description of the Related Art

Electrochemical fuel cells convert fuel and oxidant into electricity. Solid polymer electrochemical fuel cells generally employ a membrane electrode assembly that includes an ion exchange membrane or solid polymer electrolyte disposed between two electrodes typically comprising a layer of porous, electrically conductive sheet material, such as carbon fiber paper or carbon cloth. The membrane electrode assembly comprises a layer of catalyst, typically in the form of finely comminuted platinum, at each membrane electrode interface to induce the desired electrochemical reaction. In operation, the electrodes are electrically coupled for conducting electrons between the electrodes through an external circuit. Typically, a number of membrane electrode assemblies are electrically coupled in series to form a fuel cell stack having a desired power output.

The membrane electrode assembly is typically interposed between two electrically conductive flow field plates or separator plates, wherein the flow field plates may comprise polymeric, carbonaceous, graphitic, or metallic materials. These flow field plates act as current collectors, provide support for the electrodes, and provide passages for the reactant and product streams. Such flow field plates typically comprise two active surfaces with flow fields to direct the flow of the fuel and oxidant reactant fluids to the anode and cathode electrodes of the membrane electrode assemblies, respectively, and to remove excess reactant fluids and products, such as water formed during fuel cell operation. Flow field plates may further comprise manifold openings for allowing supply and exhaust of the reactant fluids and products. Optionally, the flow field plate may comprise coolant inlet and outlet manifold openings wherein a coolant is circulated to absorb heat from the exothermic reactions of the fuel cell during operation to maintain the fuel cell stack at a desired operating temperature. These manifold openings can be internal manifold openings, such that the manifold openings are formed in an extended area of the flow field plate, or can be external manifold openings, such that the manifold openings are attached to the edge of the flow field plate. The anode and cathode flow field plates may also comprise seal grooves adapted to contact the seal.

A fuel cell is one unit of a fuel cell stack wherein the fuel cell comprises a membrane electrode assembly and a seal that are situated between two flow field plates. Fuel cells and fuel cell stacks need to be sealed in order to isolate the anode and cathode electrodes and to prevent leakage of the reactant and product streams, either internally inside the fuel cell or externally into the surrounding environment. Conventional seals typically comprise two compressive surfaces: a first compressive surface that contacts and compresses against the first flow field plate and an opposing second compressive surface that contacts and compresses against the second flow field plate. A plurality of fuel cells are stacked together to form a fuel cell stack such that the manifold openings of the flow field plates communicate to form manifolds for supply and exhaust of the reactant and product streams into and out of the fuel cell stack. The fuel cells are typically connected together in series in a fuel cell stack to increase the overall output power of the fuel cell stack and are then subjected to a fuel cell stack compression pressure that is at least as high as the operating pressure to sealingly engage the seal contact points, prevent leakage of the reactant fluid and product streams, and minimize contact resistance.

During fuel cell stack operation, the reactant streams, for example, the anode fuel stream and the cathode oxidant stream, are typically pressurized to an operating pressure. The operating pressure of the anode fuel stream may be the same as the operating pressure of the cathode oxidant stream, or may be different. For example, the anode fuel stream may be employed with overpressure operation (i.e., operating at a higher operating pressure than the operating pressure of the cathode oxidant stream). In this case, the seals need to be compressed to an even higher compression pressure to accommodate the over-pressure, even though the cathode oxidant stream is operating at a lower operating pressure. With conventional seal designs, the seal load at the contacting points of the seals and the anode and the cathode flow field plates will be the same and as high as the maximum operating pressure, for example, the operating pressure of the anode when employing over-pressure operation. However, this leads to an unnecessarily high seal load at the contacting point of the seal and the cathode flow field plate, which results in high stresses on the seal and the contacting surface of the cathode flow field plate. To accommodate high seal loads, geometric modifications, such as increasing plate thickness, are required to maintain sufficient mechanical strength of the contacting surface of the flow field plate over the required lifetime of a fuel cell stack. However, these modifications are contrary to the current trend of maximizing power density of the fuel cell stack wherein one method of achieving a high power density is decreasing fuel cell stack volume such as by decreasing fuel cell stack component thicknesses. As the thickness of individual fuel cell components decreases to the micron range, thickness tolerances of individual fuel cell components tend to increase due to manufacturing variability of thin components. Furthermore, when the fuel cell components are assembled to form a fuel cell, the thickness tolerance will increase. Thus, seal design is becoming of greater importance because the seals must be able to withstand a wide range of compression pressure to compensate for the large thickness tolerance of the fuel cell.

A method to improve the reliability of the edge seal is disclosed in U.S. Pat. Appl. No. 2004/0191604 wherein a membrane electrode assembly with an improved integrated seal comprises an edge seal having an inboard pad attached to the edge of the electrodes, a flexible coupling adjacent to the pad, and a sealing element adjacent the coupling. The sealing element is significantly thicker than the pad, and the flexible coupling isolates the pad from stress experienced in the sealing element. Although this method can reduce the stress on the attached pad under stack compression pressure, the compression pressure on the sealing element and the contacting adjacent components, such as the contacting surfaces of the flow field plates, will be high particularly in the case when one of the reactant fluid streams is operated with an over-pressure.

One method to reduce the stress in the edge seal is disclosed in U.S. Pat. Appl. No. 2002/0055027 wherein a first seal has a thickness greater than the depth of the sealing groove in the flow field plates and a portion which is gradually narrowed toward an end thereof. A protrusion is provided to the sealing portion of the other separator, a second seal having a constant width is provided to the front surface of the protrusion, and the polymerized electrolytic membrane is held by the first seal and the second seal. However, this method of sealing is complicated it requires two seals to form a substantially fluid leak-tight seal and further requires that the membrane be disposed between the two seals, thus leading to mechanical stress on the membrane due to the compressive force from the seals. Furthermore, the thickness of the seals is limited so as not to tilt the electrolytic membrane when the seals compress thereon, thus limiting the geometry of the seals.

Given these problems, there remains a need to improve the seal design of fuel cells to improve seal functionality and durability. The present invention addresses these issues and provides further related advantages.

### BRIEF SUMMARY OF THE INVENTION

In a first embodiment, an edge seal member comprises a first compressive surface and an opposing second compressive surface. The first compressive surface comprises one seal protrusion, and an opposing second compressive surface comprises an inner seal protrusion and an outer seal protrusion, wherein the seal protrusion on the first compressive surface is positioned asymmetrically in relation to the positions of the inner and outer protrusions on the opposing second compressive surface. In other words, the center of the seal protrusion on the first compressive surface is offset from the centers of both the inner and outer seal protrusions on the opposing second compressive surface.

A fuel cell is formed by disposing the membrane electrode assembly (hereinafter referred to as “MEA”) and the edge seal member between a first and second bipolar flow field plate. The seal protrusion on the first compressive surface contacts an adjacent first flow field plate such that the corresponding reactant stream flowing on the first flow field plate is operating with an over-pressure, typically the fuel stream and anode flow field plate. Similarly, the inner and outer seal protrusions on the opposing second compressive surface contact an adjacent second flow field plate such that the corresponding reactant fluid stream flowing on the second flow field plate is operating at a lower pressure, typically the oxidant stream and cathode flow field plate. In addition, the inner seal protrusion on the opposing second compressive surface of the edge seal member is closer to the circumferential edge of the MEA than the outer seal protrusion on the opposing second compressive surface of the edge seal member. Therefore, the perimeter of the outer seal protrusion that circumscribes the MEA is greater than the perimeter of the inner seal protrusion that circumscribes the MEA.

The cross-section of the seal protrusions may be triangular-shaped such that the wider base of the seal protrusion is attached to a seal web of the edge seal member and the narrower end of the seal protrusion contacts a surface of an adjacent flow field plate. The narrow end of the seal protrusion may comprise a rounded tip. Such a triangular cross-sectional shape minimizes the compression load while maintaining a maximum sealing pressure at the interface of the narrower end of the seal protrusion and the contacting surface of the flow field plate. Although a triangular cross-sectional shape is more specifically illustrated herein, trapezoidal, semi-circular and rectangular shapes may be used, as well as non-symmetrical, irregular triangular shapes. By individually modifying the cross-sectional shape, geometry and positions of each of the seal protrusions, such as the radius of curvature, angle, seal height, and seal protrusion pitch, the pressure on each seal protrusion, and thus the seal load, can be controlled and optimized.

In this embodiment, at least a portion of the edge seal member material infiltrates the porous GDLs at a peripheral edge of the MEA, thus forming an integrated MEA wherein the edge seal member encapsulates and circumscribes the peripheral edge of the MEA. The MEA may be “flush-cut” such that the edges of the anode electrode, cathode electrode and membrane are substantially aligned with each other. The edge seal member material may comprise an elastomer, such as a silicone-based elastomer, ethylene-propylene-diene terpolymer (hereinafter referred to as “EPDM”), or fluoroelastomer. Alternatively, the membrane may abut from the peripheral edges of the anode and cathode electrodes (i.e., MEA is not flush-cut) to form an extended membrane region thereof wherein the edge seal member attaches and encapsulates the extended membrane region only.

In a second embodiment, the edge seal member comprises an additional manifold seal member that circumscribes at least one manifold opening of a fuel, oxidant, and coolant stream. The manifold opening may be an inlet or outlet manifold opening for supply and exhaust of the fuel, oxidant, and coolant streams. Similar to the edge seal member, the manifold seal member also comprises a first compressive surface and an opposing second compressive surface, wherein the first compressive surface is subjected to over-pressure operation and the second compressive surface is subjected to a lower operating pressure. A seal protrusion may be formed on the first compressive surface of the manifold seal member, and an inner and outer seal protrusion may be formed on an opposing second compressive surface of the manifold seal member, such that the seal protrusion on the first compressive surface of the manifold seal member is positioned asymmetrically in relation to the position of the inner and outer protrusions on the opposing second compressive surface of the manifold seal member. Alternatively, there may be only one seal protrusion on each side of the manifold seal member so that the sealing pressure will be equal on both sides of the manifold seal member. In both cases, the sealing pressure of the manifold seal member must be at least as high as the maximum operating pressure during operation in order to substantially isolate the reactant and coolant streams. This can be achieved by adjusting the geometry and shape of the seal protrusions on the manifold seal member to achieve the required sealing pressure around the manifold area. The geometry and shape of the seal protrusions on the manifold seal member need not be the same as the geometry and shape of the seal protrusions on the edge seal member.

In this embodiment, the manifold seal member may be detached from the edge seal member to form a separate seal component. Alternatively, the manifold seal member may be attached to the edge seal member so that the MEA and seals are a single integrated seal component wherein the edge seal member encapsulates the peripheral edge of the MEA or the membrane.

These and other aspects of the invention will be evidence in view of the attached figures and following detailed description.

### BRIEF DESCRIPTION OF THE DRAWINGS

In the figures, identical reference numbers identify similar elements or acts. The sizes and relative positions of elements in the figures are not necessarily drawn to scale. For example, the shapes of various elements and angles are not drawn to scale, and some of these elements are arbitrarily enlarged and positioned to improve figure legibility. Further, the particular shapes of the elements, as drawn, are not intended to convey any information regarding the actual shape of the particular elements, and have been solely selected for ease of recognition in the figures.

FIG. 1a shows a cross-sectional view of the edge seal member in the first embodiment.

FIG. 1b shows a cross-sectional view of an alternative edge seal configuration in the first embodiment.

FIG. 2 shows a cross-sectional view of the fuel cell comprising the edge seal member in the first embodiment.

FIG. 3a shows a cross-sectional view of a triangular-shaped seal protrusion on the edge seal member in the first embodiment.

FIG. 3b shows a cross-sectional view of a trapezoidal-shaped seal protrusion on the edge seal member in the first embodiment.

FIG. 3c shows a cross-sectional view of a semi-circular-shaped seal protrusion on the edge seal member in the first embodiment.

FIG. 3d shows a cross-sectional view of an irregular triangular-shaped seal protrusion on the edge seal member in the first embodiment.

FIG. 4a shows a plan view of an edge seal configuration in the second embodiment wherein the edge seal member comprises a manifold seal member.

FIG. 4b shows a cross-sectional view of an edge seal configuration in the second embodiment wherein the edge seal member comprises a manifold seal member.

FIGS. 4c and 4d show enlarged cross-sectional views of one end of alternative versions of the edge seal configuration in the second embodiment wherein the edge seal member comprises a manifold seal member.

### DETAILED DESCRIPTION OF THE INVENTION

Unless the context requires otherwise, throughout the specification and claims which follow, the word “comprise” and variations thereof, such as “comprises” and “comprising” are to be construed in an open, inclusive sense, that is as “including but not limited to”.

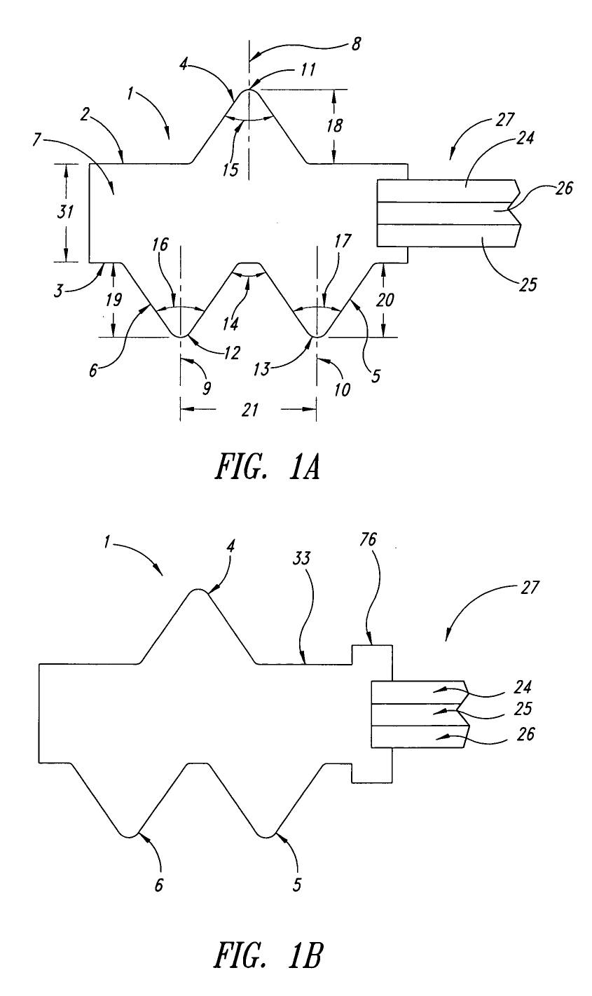

FIG. 1a shows a cross-sectional view of an edge seal member according to the first embodiment, which comprises of seal protrusion 4 on first compressive surface 2 and inner seal protrusion 5 and outer seal protrusion 6 on second compressive surface 3. Centerline 8, which is the centerline of seal protrusion 4, is asymmetrically aligned in relation to centerline 9, which is the centerline of seal protrusion 5, and centerline 10, which is the centerline of seal protrusion 6. In other words, the position of protrusion 4 on first compressive surface 2 in relation to inner protrusion 5 and outer protrusion 6 on second compressive surface 3 may be located anywhere on first compressive surface 2 so long as centerline 8 is situated between centerline 9 and centerline 10. The wider base of seal protrusions 4, 5, 6 is attached to seal web 7. Edge seal member 1 may comprise an elastomeric material, such as a silicone-based elastomer, EPDM, or fluoroelastomer. The geometry of protrusions 4, 5, 6 may be varied by changing, for example, radii 11, 12, 13, 14, angles 15, 16, 17, and heights 18, 19, 20. The flexibility in protrusion geometry helps maximize tolerance insensitivity, which can be achieved by varying geometric parameters of the edge seal member and seal protrusions as listed previously, as well as seal protrusion pitch 21 and thickness 31 of seal web 7. Furthermore, if radii 11, 12, 13 are varied together with angles 15, 16, 17, the required ratio of sealing pressures between the side of the MEA that is operating at nominal pressure and the side of the MEA that is operating with over-pressure can be easily achieved. Preferably, edge seal member 1 encapsulates MEA 27 wherein MEA 27 comprises anode electrode 24, cathode electrode 25, and membrane 26.

In this embodiment, at least a portion of the edge seal member material infiltrates anode electrode 24 and cathode electrode 26, and encapsulates MEA 27 at least around the circumference of the peripheral region of MEA 27. Alternatively, membrane 25 may extend beyond anode electrode 24 and cathode electrode 25, and the extended portion of membrane 25 is encapsulated by the edge seal member. Edge seal member 1 comprises seal protrusion 4 on first compressive surface 2, as well as inner seal protrusion 5 and outer seal protrusion 6 on second compressive surface 3. First compressive surface 2 may face and contact the flow field plate that is subjected to over-pressure operation, in this case, the anode flow field plate. Two seal protrusions 5,6 are illustrated on second compressive surface 3, wherein second compressive surface 3 faces and contacts the flow field plate that is subjected to a lower operating pressure, in this case, the cathode flow field plate. Inner seal protrusion 5 on second compressive surface 3 is closer to the circumferential edge of MEA 27 than outer seal protrusion 6. In other words, the perimeter of outer seal protrusion 6 is greater than the perimeter of inner seal protrusion 5.

In conventional seal designs, the edge seal member comprises the same number of seal protrusions on both compressive surfaces of the edge seal member. However, by having two seal protrusions on the opposing second compressive surface, such as an inner and outer seal protrusion wherein the centerline of the seal protrusion on the first compressive surface is asymmetrically aligned in relation to the centerlines of the inner and outer seal protrusions on the opposing second compressive surface, geometric stability for the seal protrusion on the first compressive surface may be achieved and the cross-sectional shape of the seal protrusions may be substantially maintained under a stack compression pressure. In addition, because the contact points of the seal protrusions are narrower than the base of the seal protrusion, the contact pressure at the contacting surfaces of the seal and flow field plate can be minimized for a particular compression pressure because the contact pressure can be easily controlled by changing the geometry of the seal protrusions. Furthermore, by having one seal protrusion on the first compressive surface of the edge seal member and two seal protrusions on the second compressive surface of the edge seal member, the contact pressure at the contacting surfaces of the seal protrusion and the first flow field plate will be high enough to accommodate a higher operating pressure while the contact pressure at the contacting surfaces of the inner and outer seal protrusions and the second flow field plate will be lower because the required sealing pressure is lower. Thus, an asymmetric sealing pressure through the thickness of the fuel cell can be achieved such that sufficient seal contact pressure is attained for sealing and isolating the two fluid streams, particularly when the anode and cathode fluid streams are operating at different pressures.

FIG. 1b shows a cross-sectional view of an alternative edge seal member according to the first embodiment having seal protrusions 4, 5, 6 that are formed on extended seal region 33 of edge seal member 1. At least a portion of inboard pad 76 infiltrates anode electrode 24 and cathode electrode 26 and encapsulates MEA 27 at least around the circumference of the peripheral region thereof. Alternatively, membrane 25 may extend beyond anode electrode 24 and cathode electrode 25 and the extended portion of membrane 25 is encapsulated by the edge seal member (not shown). In this embodiment, the total height of extended seal region 33 (i.e., from contacting surface of seal protrusion 4 to contacting surface of seal protrusion 5 or contacting surface of seal protrusion 6) is greater than the height of inboard pad 76 under a fuel cell stack compression pressure so that the total compressive stress on seal protrusions 4, 5, 6 is greater than the compressive stress on inboard pad 76.

FIG. 2 shows a cross-sectional view a fuel cell according to the first embodiment, which comprises MEA 27 and edge seal member 1. MEA 27 comprises anode electrode 24, cathode electrode 25, and membrane 26 disposed therebetween. First compressive surface 2 of edge seal member 1 may face anode flow field plate 35, which is subjected to over-pressure operation, and second compressive surface 3 of edge seal member 7 may face cathode flow field plate 36, which is subjected to lower pressure operation. Flow field plates 35, 36 may comprise of seal grooves 28, 29 to accommodate seal protrusions 4,5,6 of edge seal members 7 so that fuel cell thickness 29 can be minimized. Seal grooves 28, 29 may also assist in substantially aligning the MEA in relation to the flow field plates during fuel cell assembly. Alternatively, edge seal member 1 comprises more than one seal protrusion on first compressive surface 2 and more than two seal protrusions on second compressive surface 3, as long as all of the seal protrusions on first compressive surface 2 of edge seal member 1 are asymmetrically aligned with all of the seal protrusions on second compressive surface 3 of edge seal member 1, and second compressive surface 3 comprises one more seal protrusion than first compressive surface 2.

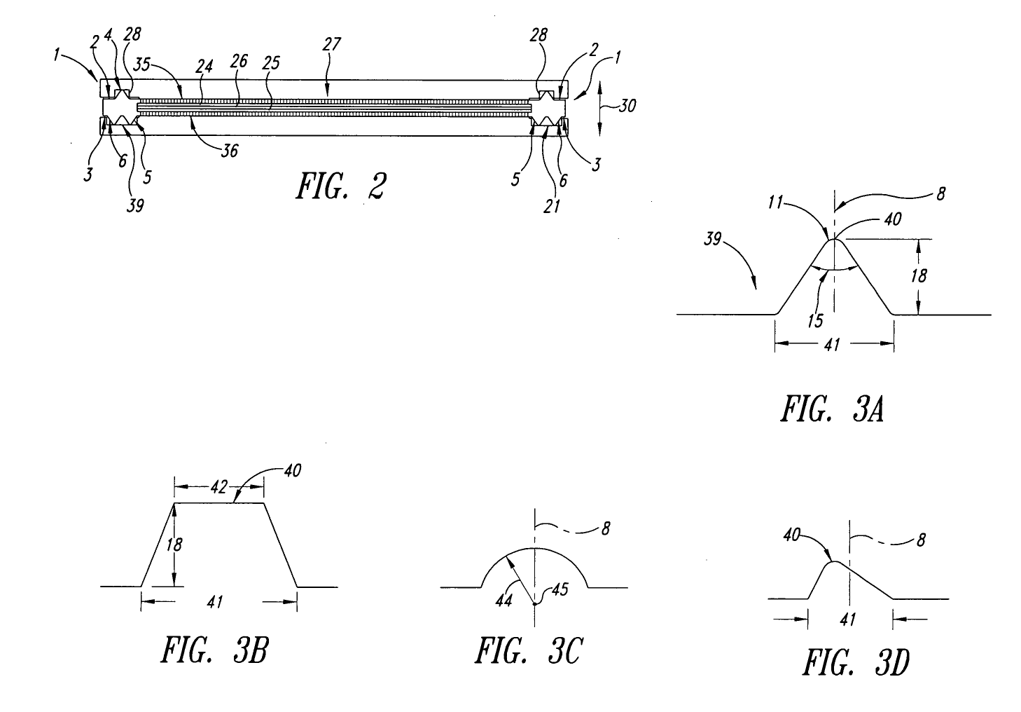

FIG. 3a shows a cross-sectional view of a triangular-shaped seal protrusion, which may be any seal protrusion of edge seal member 1. Contact point 40 may comprise a rounded tip of radius 11 that is aligned with centerline 8. The triangular shape of seal protrusion 39 may be maintained by minimizing radius 11. Angle 15 can be controlled to control the ratio of the width of contacting point 40 to the width of base 41. One of ordinary skill in the art will recognize that under a stack compression pressure, the shape of the seal protrusions may change from a triangular shape to a trapezoidal or rectangular shape.

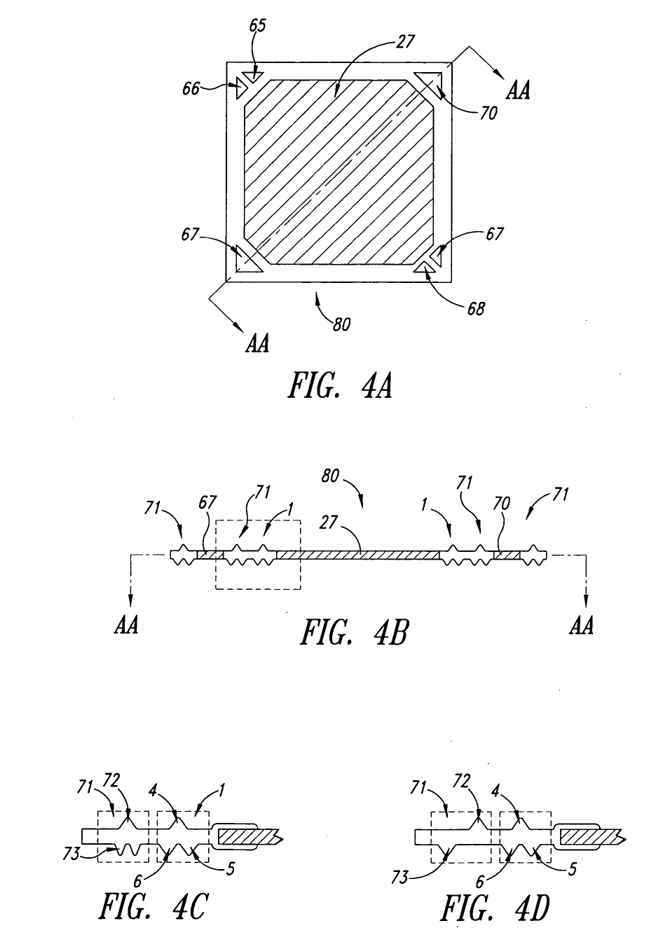

Alternatively, the seal protrusion may be trapezoidal-shaped, such as the one shown in FIG. 3b. The geometry of such a seal protrusion can be controlled by adjusting bottom width 41, top width 42 and height 18. In another alternative, the seal protrusion may be semi-circular in shape, such as the one in FIG. 3c. The geometry of such a seal protrusion can be controlled by adjusting radius 44 and the vertical position of center 45 along centerline 8. Furthermore, the seal protrusion may be irregularly shaped, such as the one shown in FIG. 3d. In this case, contact point 40 is offset from centerline 8 wherein centerline 8 is the centerline of width of base 41. Note that the seal protrusions shown in FIGS. 3a, 3b, 3c, 3d can be any of seal protrusions 4, 5, 6 of edge seal member 1 and manifold seal member 71 of FIG. 4b.

FIG. 4a shows a plan view of the first compressive surface of the edge seal member according to the second embodiment wherein edge seal member 80 circumscribes MEA 27 as well as manifold openings 65, 66, 67, 68, 69, 70 so that the edge seal member and the manifold seal member form a single integrated seal component. Manifold openings 65, 66, 67, 68, 69, 70 are formed on an extended area of the flow field plates. In a fuel cell stack, the manifold openings of each plate communicate with each other to form manifolds thereof to allow supply and exhaust of the reactant fluid and coolant streams. Alternatively, the edge seal member and the manifold seal member may be separate components (not shown).

FIG. 4b shows a cross-sectional view of integrated seal component 80 along the line defined by A-A in FIG. 4a. Manifold openings 67 and 70 are circumscribed by the seal protrusions of manifold seal member 71. FIG. 4c shows an enlarged cross-sectional view of the edge seal member and the manifold seal member defined by the box in FIG. 4b. The shape and geometry of seal protrusions 4, 5, 6 on edge seal member 1 and the shape and geometry of seal protrusion 72, 73, 74 on manifold seal member 71 may be the same or may be different. In FIG. 4c, manifold seal member 71 comprises seal protrusion 72 on the first compressive surface and a first seal protrusion 73 and second seal protrusion 74 on the second compressive surface. The geometry of first seal protrusion 73 and second seal protrusion 74 may be adjusted to obtain the same sealing pressure as seal protrusion 72 while providing adequate support and stability for seal protrusion 72.

In another alternative, as shown in FIG. 4d, manifold seal member 71 comprises one seal protrusion on both the first and second compressive surfaces. In this case, seal protrusion 72 on the first compressive surface is asymmetrically aligned in relation to seal protrusion 73 on the second compressive surface. One skilled in the art will recognize that the seal grooves of the contacting flow field plates may need to be adjusted in position and geometry to accommodate the position and geometry of the edge and manifold seal protrusions.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

What is claimed is:

1. A integrated membrane electrode assembly, comprising:
a polymer electrolyte membrane assembly comprising a porous anode electrode, a porous cathode electrode and a polymer electrolyte membrane interposed therebetween, wherein the polymer electrolyte membrane assembly is planar and comprises two major surfaces, and a circumferential edge; and
an edge seal member at the circumferential edge of the polymer electrolyte membrane assembly comprising:
a first compressive surface;
an opposing second compressive surface;
a seal protrusion on the first compressive surface; and
an inner seal protrusion and an outer seal protrusion on the second compressive surface of the edge seal member;
wherein
the seal protrusion on the first compressive surface is positioned asymmetrically in relation to the inner seal protrusion and the outer seal protrusion on the second compressive surface; and
the number of seal protrusions on the second compressive surface is at least one greater than the number of seal protrusions on the first compressive surface.

2. The integrated membrane electrode assembly of claim 1 wherein the edge seal member comprises an elastomeric material.

3. The integrated membrane electrode assembly of claim 2 wherein the edge seal member comprises a silicone-based elastomer.

4. The integrated membrane electrode assembly of claim 2 wherein the edge seal member comprises an ethylene-propylene-diene terpolymer.

5. The integrated membrane electrode assembly of claim 2 wherein the edge seal member comprises a fluoroelastomer.

6. The integrated membrane electrode assembly of claim 2 wherein at least a portion of the edge seal member saturates at least a portion of the pores of the anode and cathode electrodes at the circumferential edge thereof.

7. The integrated membrane electrode assembly of claim 1 wherein at least one of the seal protrusions are triangular.

8. The integrated membrane electrode assembly of claim 1 wherein at least one of the seal protrusions are trapezoidal.

9. The integrated membrane electrode assembly of claim 1 wherein at least one of the seal protrusions are semi-circular.

10. The integrated membrane electrode assembly of claim 1 wherein the centerline of the seal protrusion on the first compressive surface is aligned between the centerline of the inner seal protrusion and the centerline of the outer seal protrusion on the second compressive surface.

11. A fuel cell comprising a first planar flow field plate and a second planar flow field plate wherein the integrated membrane electrode assembly of claim 1 is situated between the first flow field plate and the second flow field plate.

12. The fuel cell of claim 11 wherein the first flow field plate comprises a seal groove adapted to contact the seal protrusion on the first compressive surface of the edge seal member, and the second planar flow field plate comprises a seal groove adapted to contact the inner and outer seal protrusions on the second compressive surface of the edge seal member.

13. The integrated membrane electrode assembly of claim 1 further comprising a manifold seal member, wherein the manifold seal member comprises:
a first compressive surface;
an opposing second compressive surface; and
at least one seal protrusion on each of the first compressive surface and the second compressive surface of the manifold seal member.

14. The integrated membrane electrode assembly of claim 13 wherein at least one of the seal protrusions of the manifold seal member are triangular.

15. The integrated membrane electrode assembly of claim 13 wherein at least one of the seal protrusions of the manifold seal member are trapezoidal.

16. The integrated membrane electrode assembly of claim 13 wherein at least one of the seal protrusions of the manifold seal member are semi-circular.

17. A fuel cell comprising the integrated membrane electrode assembly of claim 13 situated between a first planar flow field plate and a second planar flow field plate, at least one of the first flow field plate and the second flow field plate further comprising at least one manifold opening; wherein the seal protrusion on the first compressive surface of the edge seal member is in contact with the first flow field plate, and the inner and outer seal protrusions on the second compressive surface of the edge seal member are in contact with the second flow field plate.

18. The fuel cell of claim 17 wherein the first flow field plate further comprises at least one manifold seal groove adapted to contact the manifold seal protrusion on the first compressive surface of the manifold seal member, and the second planar flow field plate further comprises a manifold seal groove adapted to contact the manifold seal protrusion on the second compressive surface of the manifold seal member.

19. The fuel cell of claim 17 wherein the height of the seal protrusion on the second compressive surface of the manifold seal member is the same as the height of the inner and outer seal protrusion on the second compressive surface of the edge seal member.

20. The fuel cell of claim 17 wherein the height of the seal protrusion on the second compressive surface of the manifold seal member is different from the height of the inner and outer seal protrusion on the second compressive surface of the edge seal member.

21. The fuel cell of claim 20 wherein the height of the seal protrusion on the second compressive surface of the manifold seal member is greater than the height of the inner and outer seal protrusion on the second compressive surface of the edge seal member.

22. A fuel cell stack comprising a plurality of fuel cells of claim 17.

23. A method of making a membrane electrode assembly, comprising:
forming an edge seal member around a peripheral edge of a membrane electrode assembly, the membrane electrode assembly comprising an anode electrode, a cathode electrode and a polymer electrolyte membrane interposed therebetween,
wherein the edge seal member comprises:
a first compressive surface;
an opposing second compressive surface;
a seal protrusion on the first compressive surface; and
an inner seal protrusion and an outer seal protrusion on the second compressive surface;
and wherein the seal protrusion on the first compressive surface of the edge seal member is positioned asymmetrically in relation to the inner seal protrusion and the outer seal protrusion on the second compressive surface of the edge seal member.

24. A method of making a fuel cell, comprising:
interposing the membrane electrode assembly of claim 23 between a first planar flow field plate and a second planar flow field plate.

25. The method of claim 23 wherein at least a portion of the edge seal member saturates at least a portion of the pores of the anode and cathode electrodes at the circumferential edge thereof.
